(19) United States
(12) Patent Application Publication
(10) Pub. No.: US 2004/0238557 A1
(43) Pub. Date: Dec. 2, 2004

(54) Machine and methods for vending articles

(76) Inventor: Munroe Chirnomas, Morris Township, NJ (US)

Correspondence Address: AUTOMATIC IMPULSE MACHINE DESIGN INC, LAWRENCE C EDELMAN, IP COUNSEL, 1 CORY RD, MORRIS TOWNSHIP, NJ, 07960, US

(21) Appl. No.: 10/496,285

(22) PCT Filed: Nov. 25, 2002
(86) PCT No.: PCT/US02/37790

Related U.S. Application Data
(60) Provisional application No. 60/332,518, filed on Nov. 23, 2001.

(51) Int. Cl. B65G 59/00; G07F 11/00; B65H 3/44

(52) U.S. Cl. 221/124

(57) ABSTRACT

A method and apparatus for vending articles (12) from a machine (10). The machine includes an interior space (102) having at least one compartment (140) for storing articles (12) extending along a horizontal axis (142) between first (144) and second (146) ends. A head (270) is provided to engage the articles (12) when positioned in alignment with a compartment (140) by a positioning mechanism (210). The head (270) is extended into a compartment (140) parallel to the horizontal axis (142) to engage an article (12).

### CROSS-REFERENCE TO RELATED APPLICATIONS

This application claims priority under 35USC 120 of U.S. Provisional Patent Application No. 60/332,5180 filed Nov. 23, 2001, entitled “Machine For Vending Articles And Methods Associated Therewith”. The entire disclosure of this patent application is incorporated herein by reference in its entirety.

### SUMMARY OF THE INVENTION

The present invention provides a machine for vending articles according to a first embodiment. The machine includes at least one compartment including a guide, a head, and a positioning mechanism. The compartment, which is adapted to store the articles, extends along a longitudinal axis extending between first and second ends. The guide extends parallel to the longitudinal axis. The head is extensible into the compartment along a first axis that is generally parallel to the longitudinal axis, and is adapted to engage one of the articles. The positioning mechanism aligns the head with the guide. In a preferred embodiment, the longitudinal axis is generally horizontal. The guide can simply be the walls or floor of the compartment, which cooperates with the head.

The present invention also provides a machine for vending articles according to a second embodiment. The machine includes at least one compartment, a head, a positioning mechanism, and a guide. The compartment, which is adapted to store the articles, includes a generally horizontal axis that extends between first and second ends. The head, which is adapted to engage one of the articles, is extensible into the compartment along a first axis that is generally parallel to the generally horizontal axis. The positioning mechanism aligns the head with the compartment. The guide, which is provided in the compartment, controls lateral movement of the head with respect to the first axis. Again, the guide can simply be the walls or floor of the compartment, which cooperates with the head.

The present invention also provides a machine for vending articles according to a third embodiment. The machine includes at least one compartment, a head, a guide, a hose, a feeder, and a positioning mechanism. The compartment includes a longitudinal axis that extends between first and second ends. The first end defines an article portal The head, which is adapted to engage one of the articles, is extensible through the first portal, along a first axis that is generally parallel to the longitudinal axis, and into the compartment. The guide, which controls lateral movement of the head with respect to the first axis, is provided in the compartment. The hose provides a fluid coupling between the head and a vacuum source. The feeder displaces the hose so as to extend the head along the first axis. The positioning mechanism aligns the head with the compartment.

The present invention additionally provides a method of vending articles from a machine. The machine includes an interior space that has therein at least one compartment, which extends along a generally horizontal axis between first and second ends. The compartment has therein a plurality of articles. The method includes aligning a head, which is adapted to engage the articles, with the compartment; extending the head into the compartment along a first axis that is generally parallel to the generally horizontal axis; engaging one of the plurality of articles with the head; and retracting the head, with the article engaged by the head, along the first axis. The engaging and retracting leave substantially undisturbed non-engaged ones of the plurality of articles.

The present invention further provides a method of stocking a machine for vending articles. The method includes accessing a compartment, which includes a generally horizontal axis extending between first and second ends, in an interior space of the machine; and inserting into the compartment, along the generally horizontal axis, at least one of the articles.

### BRIEF DESCRIPTIONS OF THE DRAWINGS

The accompanying drawings, which are incorporated herein and constitutes part of this specification, illustrate embodiments and details of the invention, and, together with the general description given above and the detailed description given below, serve to explain the features of the invention.

FIG. 1 is a partially cutaway, perspective view of a vending machine.

FIG. 2 is a partially cutaway, perspective view of a detail of the vending machine shown in FIG. 1.

FIG. 3 is a schematic view of a further arrangement for the vending machine shown in FIG. 1.

FIG. 4 is a schematic view illustrating a detail of the vending machine shown in FIG. 1.

FIG. 5 is a schematic view illustrating a further arrangement for the vending machine shown in FIG. 1.

FIG. 6 is a schematic view illustrating a further arrangement of the detail shown in FIG. 2.

FIG. 7A is a first schematic view illustrating the detail shown in FIG. 2.

FIG. 7B is a second schematic view illustrating the detail shown in FIG. 2.

FIG. 8 is a schematic view illustrating a detail of the vending machine shown in FIG. 1.

### DETAILED DESCRIPTION OF THE PREFERRED EMBODIMENT

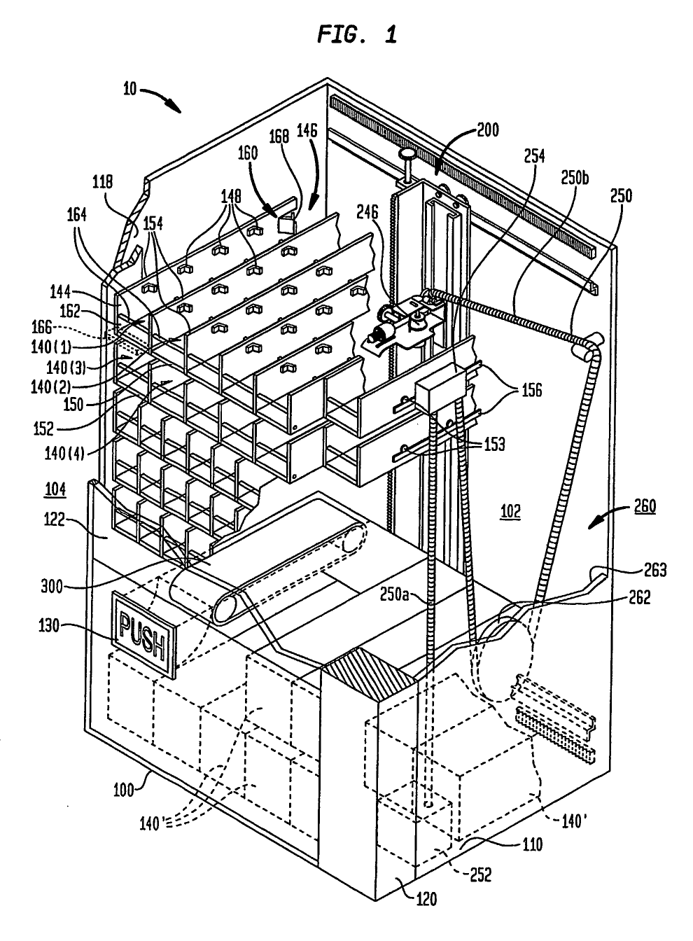

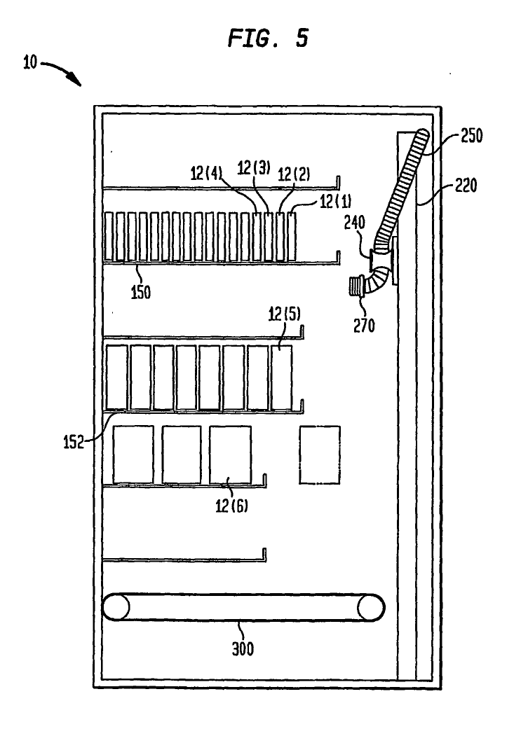

Referring to FIG. 1, a machine 10 for vending articles 12(1)-12(6) (such articles being shown in FIG. 5) includes an enclosure 100 and a handler 200.

In general, the articles 12 can include various consumer products. Preferably, the articles 12 can be food or beverages (e.g., bags of snacks, packs of gum, candy bars, ice cream novelties, individual serving size pizzas, cans of carbonated beverages, containers of juice, etc.), personal hygiene items (e.g., combs and hair brushes, lip balm, razors, bandages, etc.), office supplies (e.g., pens and pencils, staples, note pads, tape, pre-paid), etc. Of course, it is possible for the machine 10 to store and vend other types of goods and services (e.g., telephone calling cards, cinema tickets, etc.).

The machine 10 can include various types of equipment to prepare the articles 12. For example, the machine 10 can include refrigeration equipment to keep certain articles cool or frozen. The machine 10 can also include heating equipment, e.g., a microwave oven, to warm certain articles.

The enclosure 100 can include a body 110 and a door 120. The enclosure 100 defines an interior space 102 that is thereby separated from a surrounding exterior space 104. In general, the enclosure 100 provides a container for the articles 12, which are to be selectively dispensed to the exterior space 104. Preferably for a traditional vending machine environment, the enclosure occupies a space of approximately (i.e., +/−30% of) 3 feet by 3 feet by 6 feet, and in another environment, it could be much larger and have a different form factor, such as 20 feet long, by 8 feet high by 8 feet deep.

The body 110 can have a variety of arrangements including a free standing cabinet or a room within a building. In general, the body 110 defines a cavity that is accessible primarily via an aperture 118 at the mouth of the cavity. The door 120 can be movable, with respect to the body, between a first position that occludes the aperture 118 and a second position that provides access to the interior space 102. For example, the door 120 can be pivotally mounted with respect to the body 110 via hinges, and a latching mechanism can be used to retain the door 120 in the first position. A lock can be used with the latch to provide security.

Either the body 110 or the door 120 can have an at least partially transparent panel 122 that permits viewing of the interior space 102. Thus, the articles 12 being vended or the handler 200 can be viewed from the exterior space 104. Graphics or indicia, such as advertising for the articles 12 or the machine 10, can be place on any portion of body 110, the door 120, or the transparent panel 122. Lighting can also be provided in the interior space 102 to enhance viewing through the transparent panel 122.

A receptacle 130 can provide a space that provides limited access between the interior space 102 and the exterior space 104. The receptacle 130 can have a variety of arrangements including interlocked double doors or an elongated passage. In general, the receptacle 130 facilitates dispensing and customer retrieval, and at the same time prevents vandalism, of the articles 12 within the machine 10. The receptacle 130 can be part of either the body 110 or the door 120.

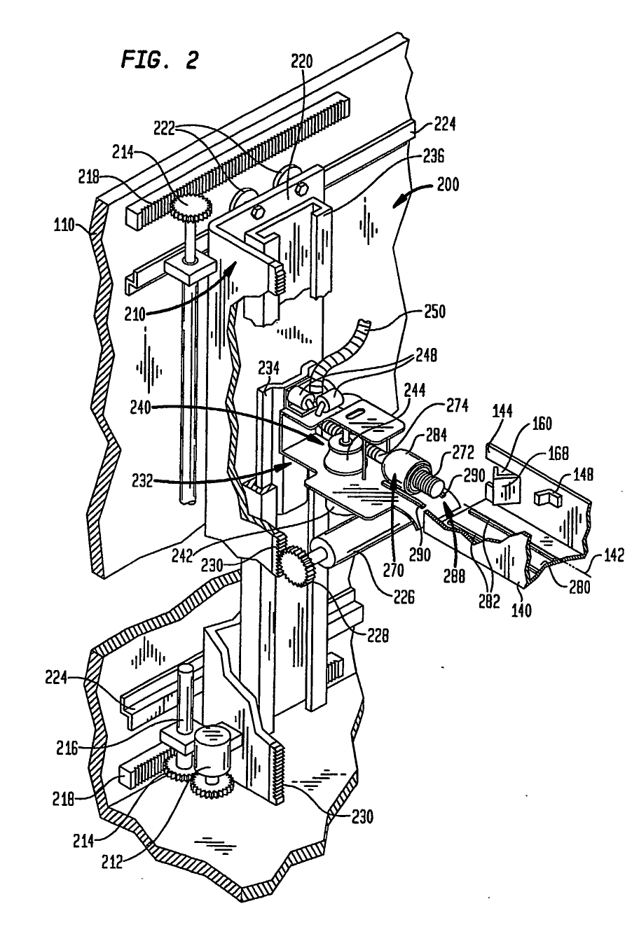

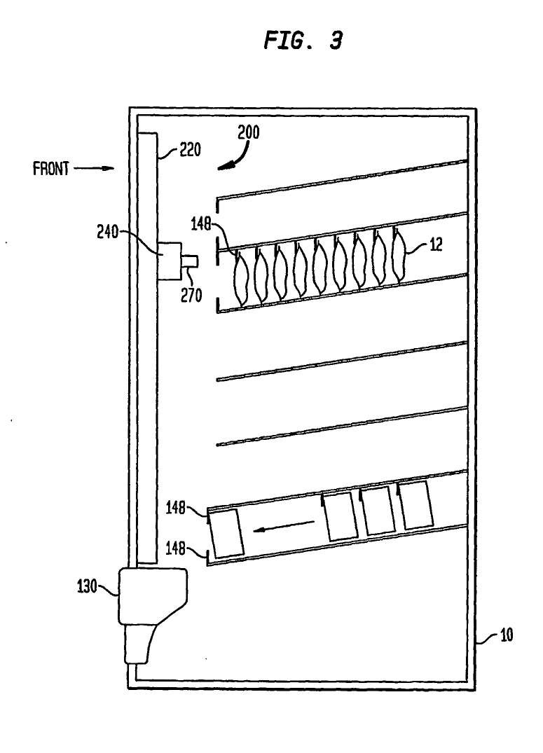

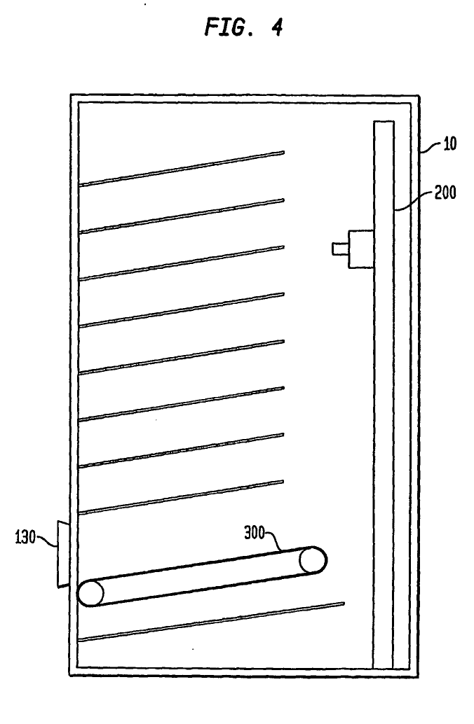

The interior space 102 can be partitioned into a number of compartments 140(1) to 140(4). Referring also to FIG. 2, each of the compartments 140 has a longitudinal axis 142 extending between a first end 144 and a second end 146. The longitudinal axis 142 can extend horizontally (i.e., parallel to the horizon), vertically (i.e., parallel to the force of gravity), or generally horizontally (i.e., at angle between horizontal and vertical; see FIGS. 3 and 4).

Each compartment 140 can store at least one of the articles 12. The number and type of articles 12 that are stored in a respective compartment 140, or the number of compartments 140 holding a particular type of article 12, can be changed during stocking, as will be described more fully hereinafter.

The width and height dimensions of the compartments 140, i.e., measured transverse to the longitudinal axis 142, can be selected to accommodate the corresponding dimensions of one or more types of articles 12. The depth dimension of the compartments 140, i.e., measured along the longitudinal axis 142, can be selected to accommodate a predetermined number of a particular type of article 12. As will be described more fully hereinafter, the depth dimension may also be related to location of the compartment 140 within the enclosure 100.

One or more tabs 148 can project inward into the compartment 140. PCT/US01/16847, filed May 23, 2001, entitled METHOD AND APPARATUS FOR STORING ARTICLES FOR USE WITH AN ARTICLE HANDLING DEVICE, incorporated herein by reference, describes various configurations of inwardly projecting tabs. In general, the tabs 148 maintain the orientation or spacing of the articles within the compartment 140, and specifically ensures that the articles are presented in uniform manner so as to facilitate the head 270 contacting a desired surface of the article. The tabs can be made of a flexible material which has a memory, such as a plastic or metal spring-like material, which is able to support the package, but also flex out of the way during the article dispensing procedure. As described more fully in the above noted PCT/US01/16847, in the event that the compartments 140 are portable, and as such are transported from a warehouse to the machine 10, tabs 148 may also function as supports for the weight of the articles, so that the force of gravity is prevented from crushing articles positioned near the lower portions of the compartments 140, when such compartments are in a vertical orientation.

The compartments 140 can be grouped into sets. For example, a generally horizontal row of compartments 140(1)-140(2) may define first set of compartments 140, and another generally horizontal row of compartments 140(3)-140(4) may define a second set of the compartments 140.

A first tray 150 may define a common base for simultaneously manipulating the compartments 140 of the first set, and a second tray 150 may define a common base for simultaneously manipulating the compartments 140 of the second set. For example, the trays 150,152 may each include a shelf that is displaceable fore and aft, i.e., parallel to the longitudinal axes 142. Rollers 153 and cooperating ledges 156 may provide an antifriction device facilitating the fore and aft displacement of the trays 150,152. Preferably, the rollers 153 are mounted on the trays 150,152 and the body 110 provides the ledges 156.

Walls 154 that separate an adjacent pair of compartments 140 within a set may define the compartments 140 of the first and second sets. Or compartments 140 defined by independent structures may be placed on the trays 150,152. It is also envisioned that the trays 150,152 could have a common depth dimension, i.e., parallel to the longitudinal axes 142, and that compartments 140 having different depth dimensions could be placed on the trays 150,152.

As shown in FIG. 1, the compartments 140 may be fitted with a system 160 that prevents articles from being pushed out the second end 146 during axial stocking of the articles 12 from the first end 144. The system 160 may include at first end 144 a panel 162 that is pivotal from a vending position 164 (as shown in solid lines) to a stocking position 166 (as shown in broken lines). The panel 162 may be operatively connected, e.g., by a Bowden cable, to a retention projection 168 that is movable into a blocking arrangement that at least partially occludes the second end 146. The retention projection 168 may include an accordion type device that is substantially flat in the vending position 164 and, when the panel 162 is pivoted to the stocking position 166, has a central portion that is raised due to pulling by the Bowden cable. Thus, when the compartment 140 is being stocked by pushing articles 12 along the longitudinal axis 142 from the first end 144, the panel 162 is pivoted to the stocking position 166, and the retention projection 168 prevents articles 12 from being pushed out the second end 146. When the compartment 140 is sufficiently stocked with articles 12, the panel 162 is pivoted to the vending position 164 to prevent articles 12 from being pushed out of the first end 144 when articles are retrieved from the second end 146 of that compartment. Pivoting of panel 162 also operates the Bowden cable and causes the raised central portion of retention projection 168 to again take a flat position, thereby allowing the handler 200 to remove articles 12 to be vended from the second end 146. An advantage of axial stocking is that the article 12 that is stocked in the compartment 140 first in time, is also the article 12 that is first in time to be removed for vending, and the article 12 that is stocked in the compartment 140 last in time, is also the article 12 that is last in time to be removed for vending.

Of course, the system 160 can have different configurations. For example, the panel 162 may be pivotally mounted with respect to the compartment 140 about a vertical axis rather than a generally horizontal axis. The panel 162 may be moved with respect to the compartment 140 by an action other than pivoting. A substantially rigid link, rather than the relatively flexible Bowden cable, may be used to operatively connect the panel 162 and the retention projection 168. And the retention projection 168 can include structures and operations other than an accordion type device. Additionally, panel 162 can be at least partially transparent so as to display (i.e., merchandise) the article 12 proximate the first end 144, or a structure other than a panel, e.g., a handle, can be substituted.

In a further embodiment of the machine 10, the trays 150,152 may be moved aft, i.e., into the body 110, during stocking so that the second ends 146 abut an interior surface of the body 110. That is to say, the trays 150,152 can be moved aft, through the working space of the handler 200, such that the body 110 occludes the second ends 146. Thus, the body 110 prevents the articles 12 from being pushed out the second end during axial stocking from the first end 144. As will be described hereinafter, the structure of the handler 200 may at least partially interfere with the trays 150,152 being moved aft against the body 110. In this instance, the trays 150,152 may include a notch that receives the handler 200, and the handler 200 may also prevent articles 12 from being pushed out the second end during axial stocking from the first end 144.

A yet further embodiment of the machine 10 can have the trays 150,152 movable fore, i.e., out of the body 110 (when the door 120 is in its second, i.e., open, position) so as to gain generally unrestricted access to the first and second ends 144,146. Thus, during axial stocking, the first end 144 can be manually occluded. Or if the compartment 140 has an open side, such as when the compartment 140 is defined by the trays 150,152 and walls 154, articles 12 may be stocked transversely to the longitudinal axis 142. It is also envisioned that the trays 150,152 may have a compound movement. For example, at the extent of fore movement parallel to the longitudinal axis 142, the trays 150,152 may be pivoted to an inclined or vertical orientation to further facilitate stocking.

The machine 10 maximizes the volume of the compartments 140 within the interior space 102 and minimizes the volume required for the handler 200 and additional equipment (e.g., control panel, vacuum source, refrigeration/heating equipment, etc.). Preferably, at least 75% of the interior space 102 is devoted to storage for the articles 12, and less than 25% of the interior space 102 is required for the handler 200 and additional equipment. Specifically, with a handler 200 as shown herein, less than 20%, and preferably closer to 15%, or even less, of the interior space 102 is required for the handler.

In order to maximize the interior space 102 devoted to storage for the articles 12, various configurations and arrangements of the compartments 140 are envisioned. For example, it is envisioned that at least some of the compartments 140 that are located behind the control panel or around other equipment may have a reduced depth dimension so as provide an accommodation for the volume occupied by the control panel or other equipment. These reduced depth compartments 140′, which may not be viewable through partially transparent panel 122, can be used as additional storage capacity for frequently vended articles 12. In this situation, the machine 10 could vend the articles 12 from these reduced depth compartments 140 prior to depleting the same articles 12 from a compartment 140 that has its first end 144 that is viewable through the partially transparent panel 122.

The interior space 102 devoted to storage for the articles 12 could also be maximized, and the volume of the working space required by the handler 200 could be minimized, by staggering the depth dimensions of different ones of the trays 150,152. In general, less space is needed at the second end 146 of the compartment 140 for the handler 200 to move smaller articles 12. For example, referring additionally to FIG. 5, the smallest volume articles 12 may be placed in compartments 140 on the uppermost tray 150, and progressively larger articles 12 may be placed on successively lower trays 152 in compartments 140 that have progressively shallower depth dimensions. Thus, the space necessary for moving the articles 12 between the second ends 146 and the handler 200 can be reduced, and the available depth for storage in the compartment 140 can be increased, in accordance with size of the articles 12.

The handler 200 moves the article 12 selected by a consumer from its compartment 140 to the receptacle 130, whereupon the consumer can withdraw the article from the receptacle 130. Of course, the movement by the handler 200 may include a first movement from the compartment 140 to processing equipment, e.g., a microwave oven, within the enclosure 100, and a second movement from the processing equipment to the receptacle 130. The movement by handler 200 may additionally include opening a closure, e.g., a thermal door, in the course of moving the article 12 about the inside of enclosure 100.

The handler 200 can include a positioning mechanism 210, a feeder 240 supported by the positioning mechanism 210, a hose 250 that is advanced and retracted by the feeder 240, a head 270 that is displaced by the hose 250 and that engages one of the articles 12, and a guide 290 that assists controlled movement of the head 270. These and other features of the handler 200 will now be described hereinafter.

The positioning mechanism 210 can provide movement to any point on a plane that confronts the second ends 146 of the compartments 140. The movement in the plane can be achieved by different motions and with different actuators.

Examples of the different motions can include X-Y coordinate movement, or r-Θ coordinate movement. In the case of X-Y coordinate movement, a first movement is translation along a first axis and a second movement is translation along a second axis that is perpendicular to the first axis. In the case of r-Θ coordinate movement, a first movement is rotation about a first axis and a second movement is translation along a second axis perpendicular to the first axis.

Examples of different actuators that can implement translation include a pinion driving a rack, a threaded shaft driving a cooperating nut, a pinion driving a cog belt that extends around spaced pulleys, a pneumatically or hydraulically extensible and retractable set of telescopically nested rods, relatively displaceable articulately related links (e.g., a scissors linkage), etc. Examples of different actuators that can implement rotation include a motor, a rack driving a pinion, etc.

Referring to FIG. 2, there is shown an example of a X-Y coordinate movement using pinions driving a rack. A first motor 212 turns a pair of gears 214 that are fixed for common rotation via a shaft 216. The gears 214 are operatively engaged with respective racks 218 which are fixed to the body 110. The first motor 212 and bearings for the shaft 216 are supported on a beam 220. In turn, the beam 220 is supported for translation relative to the body 110 by antifriction wheels 222 riding in channels 224. Thus, rotation of the first motor 212 causes rotation of the gears 214 with respect to the racks 218, which in turn causes the beam 220 to translate in a first side-to-side direction. Reversing the rotation of the first motor 212 will cause the beam 220 to translate in a second side-to-side direction that is opposite to the first side-to-side direction.

A second motor 226 turns a gear 228 that is operatively engaged with a rack 230 that is fixed to the first beam 220. The second motor 212 is supported on a carriage 232. In turn, the carriage 232 is supported for translation along the beam 220 by flanges 234 sliding in channels 236. Thus, rotation of the second motor 226 causes rotation of the gear 228 with respect to the rack 230, which in turn causes the carriage to translate in a top-to-bottom direction. Reversing the rotation of the motor 226 will cause the carriage 232 to translate in a bottom-to-top direction.

In an embodiment where the enclosure occupies a space of approximately (i.e., +/−30% of) 3 feet by 3 feet by 6 feet, the carriage 232 preferably works in a space of less than approximately (i.e., +/−30% of) 10 inches of the depth dimension of machine 10.

Thus, a first positioning mechanism, which includes the first motor 212 and the racks 218, accomplishes a first translation movement that is perpendicular to a second translation movement that is accomplished by a second positioning mechanism, which includes the second motor 226 and the rack 230.

In further embodiments of the machine 10, both of the positioning mechanisms can be similarly supported with antifriction wheels and channel arrangements or with flanges sliding in channels. Different numbers of wheels, flanges, and channels may be implemented. And actuators other than pinions driving racks may be implemented. Also in a further embodiment, the first beam 220 could translate top-to-bottom and bottom-to-top, and the carriage 232 could translate side-to-side relative to the first beam 220.

The feeder 240 is supported on and moves with the carriage 232. The feeder 240 includes a third motor 242 which turns a drive roller 244. The drive roller 244 contiguously engages the surface of the hose 250. An idle roller 246 (shown in FIG. 1) is biased against the hose 250 so as to ensure that the engagement between the drive roller 244 and the surface of the hose 250 is sufficient to convert rotation of the drive roller 244 to extension of the hose 250 from the plane of the positioning mechanism 210. Reversing rotation of the third motor 242 retracts the hose 250.

In a further embodiment of the machine 10, at least the drive roller 244 can have a texture that cooperatively engages a corresponding texture on the surface of the hose. In yet a further embodiment of the machine 10, a threaded rod can be driven by the third motor 242 and can cooperatively engage corrugations on the surface of the hose 250, or in some other way drive head 270 into the storage compartments.

The carriage 232 can further include one or more guide rollers 248 for aligning the hose 250 with the feeder 240. Preferably, these guide rollers 248 are located at positions where the hose 250 is required to flex or bend. A further embodiment of a feeder is shown in PCT/US01/16894, filed May 23, 2001, entitled METHOD AND APPARATUS FOR POSITIONING AN ARTICLE HANDLING DEVICE, incorporated herein by reference.

The hose 250 is extensible and retractable along an axis that can be orthogonal to the plane of movement in which the positioning mechanism 210 positions the carriage 232. Referring again to FIGS. 1 and 2, for example, the positioning mechanism 210 can locate the carriage 232 vertically and laterally so as to select one of a plurality of the generally horizontally oriented compartments 140, and the feeder 240 can extend and retract the hose 250 along a generally horizontal axis so as to enter and withdraw, respectively, from the selected compartment 140.

The hose 250 can include more than one portion. For example, FIG. 1 shows a first hose portion 250a and a second hose portion 250b. The first hose portion 250a provides a fluid coupling between a vacuum source 252 and a hose junction box 254 which box can contain within it an air flow sensor and a vacuum release valve. The second hose portion 250b provides a fluid coupling between the hose junction box 254 and the head 270.

In further embodiments of the machine 10, the hose 250 can be extensible and retractable along an axis that is oblique, i.e., not orthogonal, with respect to the plane of movement in which the positioning mechanism 210 positions the carriage 232.

Similarly, the hose 250 can be considered with respect to the feeder 240. That is to say, a first hose segment can be considered to be the length of the hose 250 extending between the feeder 240 and the vacuum source 252, and a second hose segment can be considered to be the length of the hose 250 extending between the feeder 240 and the head 270. As the feeder 240 extends the hose 250, the first hose segment decreases and the second hose segment increases, and as the feeder 240 retracts the hose 240, the first hose segment increases and the second hose segment decreases. In a further embodiment of the machine 10, a hose storage system 260 can be used to arrange the first hose segment. The hose storage system 260 can be arranged vertically, as shown in FIG. 1, and can include a pulley 262 contiguously engaging the first hose segment, with the pulley and hose segment constrained in a space defined by an outer wall of the housing 100, and an inner wall 263. The pulley 262 can be biased gravitationally (e.g., by a weight, as shown in FIG. 1), biased resiliently (e.g., by a spring), or biased mechanically (e.g., by a linkage). In a further embodiment of the machine 10, the hose storage system 260 can be oriented generally horizontally with the pulley 262 biased resiliently or mechanically. A further embodiment of a hose storage system is shown in the forenoted PCT/US01/16894.

The head 270 can be in fluid communication with the vacuum source 252 via the hose 250, and can be displaced by the feeder 240 via the hose 250. The head 270 can include a suction cup 272 and a rotary joint 274. The suction cup 272 can include a flexible member that is activated by the vacuum source 252 so as to grip one of the articles 12. In general, the head 270 provides a gripper that releasably holds an article 12 such that the article 12 can be moved with the head 270. The rotary joint 274 can couple the head 270 to the hose 250 so that a preferred orientation of the head 270 can be maintained as the hose 250 is extended and retracted by the feeder 240.

In further embodiments of the machine 10, the head 270 can include a mechanical gripper or a magnetic gripper. With either of these grippers, a link that is laterally flexible and generally non-deformable longitudinally, but not necessarily hollow, can be used to extend/retract the head 270 using the feeder 240. Either of these grippers can be operated to grip an article 12 with an actuator at the head 270 or by a remotely located actuator, e.g., one located at an end of the link that is opposite the head 270.

The hose 250 has a generally constant length and has sufficient flexibility to be bent as necessary in the feeder 240 and the hose storage system 260. Thus, the distance that the hose 250 extends from the feeder 240 (i.e., the second segment of the hose 250) is readily determinable by operation of the feeder 240.

In accordance with another aspect of the present invention, to control the direction that the hose extends from the feeder 240, a guide 280 provides some control of the lateral flexibility of the hose 250 as it is extends into the compartments 140 by guiding the head 270 in the guide 280. Referring to FIG. 2, the guide 280 can include a pair of tracks 282 that are provided in the compartment 140. These tracks 282 define a path along which the head 270 is guided while being extended to engage an article 12, and along which the head 270 and an engaged article 12 are retracted.

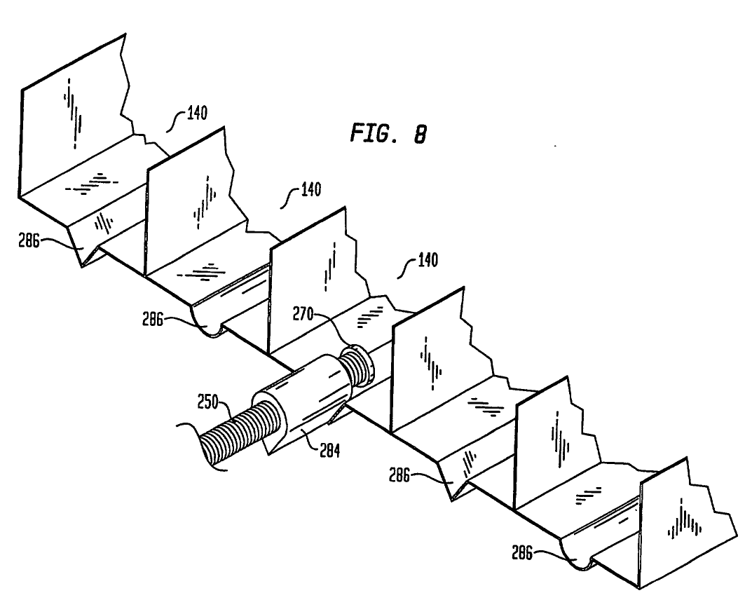

In general, the guide 280 within the compartment 140 can be a step portion that extends parallel to the longitudinal axis 142. Referring to FIG. 8, a further embodiment of the machine 10 can have a guide 280 that includes grooves 286 in the compartments 140. These grooves 286 can cooperatively interact with the enlarged portion 284 so as to orient the suction cup 272 to grip an article 12, and to prevent the suction cup 272 from gripping the surfaces of the compartment 140.

The guide 280 can also include the enlarged portion 284 of the head 270. The enlarged portion 284 is sized to cooperatively interact with the tracks 282 such that the suction cup 272, which is of a smaller diameter than the enlarged portion 284, is oriented to grip an article 12 while preventing the suction cup 272 from contacting or gripping the surfaces of the compartment 140.

The feeder 240 can also include a platform 288 that projects from the feeder 240 toward the second ends 146, i.e., at least partially bridging the working space between the positioning mechanism 210 and the second ends 146 of the compartments 140. Platform 288 provides a substantially smooth and controlled transition for the head 270 over the bridge and may thus be considered a guide for the head 270. The platform 288 can include tracks 290 corresponding to the tracks 282. Like the tracks 282, the tracks 288 also define the path along which the head 270 is guided while being extended to engage an article 12, and along which the head 270 and an engaged article 12 are retracted. Further, the platform 288 can provide a support for an article 12 while the positioning mechanism 210 is operated. Note, platform 288 can have a downward curve to further facilitate the transition. Furthermore, the enlarged portion 284 of the head 270 can have beveled or rounded front and rear edges to facilitate its movement between compartment 140 and feeder platform 288.

The platform 288 shown in FIG. 2 projects from the feeder 240 a fixed distance. In a further embodiment of the machine 10, for example as shown in FIG. 5, the platform 288 can have a variable length that adjustably projects from the feeder 240 in accordance with the working space between the handler 200 and the second end 146 of a compartment 140.

In a further embodiment of the machine 10, the feeder 240 can include an extendable structure that is relatively rigid with respect to the hose 250. The extendable structure includes a first portion which supports the head 270 and a second portion secured to the feeder 240. Preferably, the extension can include a coil of spring metal, which is wound by a spring (similar to a tape measure), that is supported by the feeder 240, and can further include a member that attaches to or supports the head 270. An alternative embodiment could be a scissor type device.

In an even further alternative embodiment, the guide may simply be a combination of the walls and or floor of the compartments, in combination with a suitably designed head. One specific head design could include a flexible/spring-type radial extension of the head, where cooperation of the flexible/spring-type radial extension with the walls and or floor of the compartments provides the guidance necessary to keep the head centered for entering, exiting, and during its movement within, the compartment.

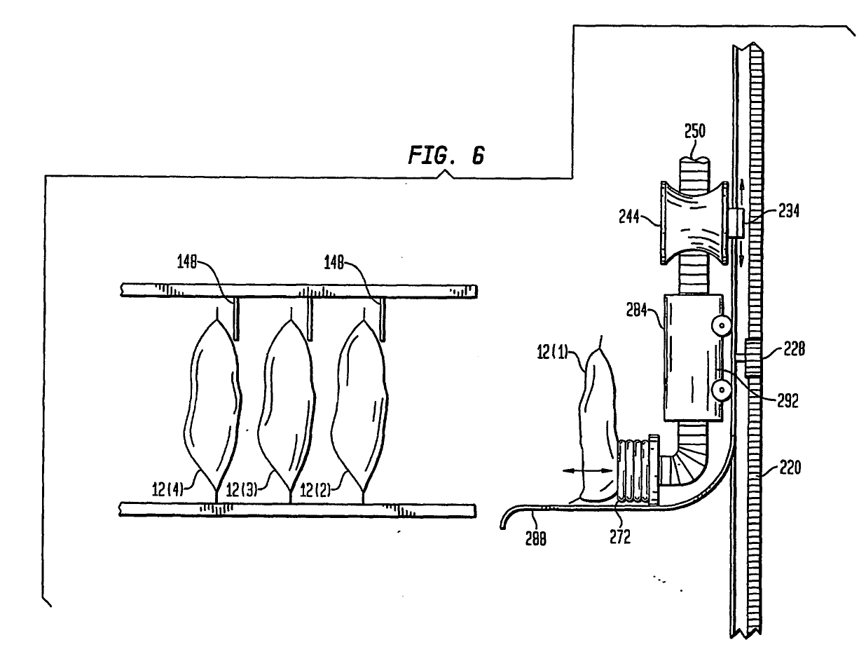

Referring to FIG. 6, a further embodiment of the head 270 can include a dolly 292 with wheels that shuttles between the platform 288 and the compartment 140. Such wheels can engage or ride on guide tracks in the compartment 140.

In accordance with another aspect of the present invention, when the handler is not located at the front of the machine, a transfer mechanism 300 can be provided to assist with movement of the articles 12 from the head 270 to the receptacle 130. As shown in FIGS. 1, 4, and 5, the transfer mechanism 300 can be a conveyor upon which the head 270 releases the article 12 at the back of the machine 10, which mechanism 300 then transfers the article 12 to the front of the machine 10, and places the article 12 in the receptacle 130.

In a further embodiment of the machine 10, the transfer mechanism 300 can include a chute, i.e., a passive guide that does not have a conveyor. In the case of the handler 200 being located at the front of the machine 10, as shown for example in FIG. 3, the head 270 can release an article 12 into the chute, which article then slides under the influence of gravity, through the chute to the receptacle 130. In the event that the trays 150, 152 are not sufficiently inclined so that the remaining articles slide to the front, the handler 200 can go into a compartment 140 and bring the next to be dispensed article to the front of the machine. In the case of the handler 200 being located at the rear of the machine 10, the chute can include a first portion that is similar in configuration and orientation to an empty compartment, and a second portion that couples the first portion to the customer receptacle. In this latter case, the feeder 240 can push the article 12 through the first portion of the chute, and release it in the second portion of the receptacle. Alternatively, if the chute had a sufficient inclination, the force of gravity may allow an article released at the first portion to slide under the influence of gravity to the second end.

A method of vending the articles 12 will now be described with respect to the embodiment shown in FIGS. 1 and 2. The positioning mechanism 210 can align the head 270 with the second end 146 of a compartment 140. The feeder 240 can then extend the hose 250 so as to displace the head 270 into the compartment 140. The head 270 can engage the first encountered article 12, while leaving substantially undisturbed other, non-engaged articles 12 in the compartment 140. The feeder 240 can then retract the hose 250 so as to withdraw the head 270 with the one article 12 engaged thereto, while leaving substantially undisturbed the other, non-engaged articles 12 in the compartment 140. Once the article is on the platform 288, the positioning mechanism can transport the article to the transfer mechanism 300 and release its grip on the article, thereby allowing the transfer mechanism 300 to transport the article from the rear of machine 10 to the receptacle 130 at its front door 120. The platform 288 can be hinged so to retract and allow the product to fall onto the transfer mechanism 300, or the head 270 could push the article onto the transfer mechanism 300.

According to a further method, the machine 10 displays the article 12 that is proximate the first end 144 of the compartment 140. The article 12 that is displayed can be viewed through the at least partially transparent panel 122 and the panel 162. This displayed article 12 is consequently the last of the articles 12 removed from the compartment 140 such that the depletion of the articles 12 is indicated only when none of that article 12 is displayed.

In the event that the articles are cylindrical containers, such as a beverage container, or other types of container that may change their orientation if disturbed, since the apparatus of the invention does not disturb the articles remaining the compartment, it allows the label on the articles to remain facing the front of the machine, substantially undisturbed by the dispensing process, until that last article in the compartment is retrieved. This aspect of the invention insures that the article label is properly displayed and merchandised at all times to potential customers.

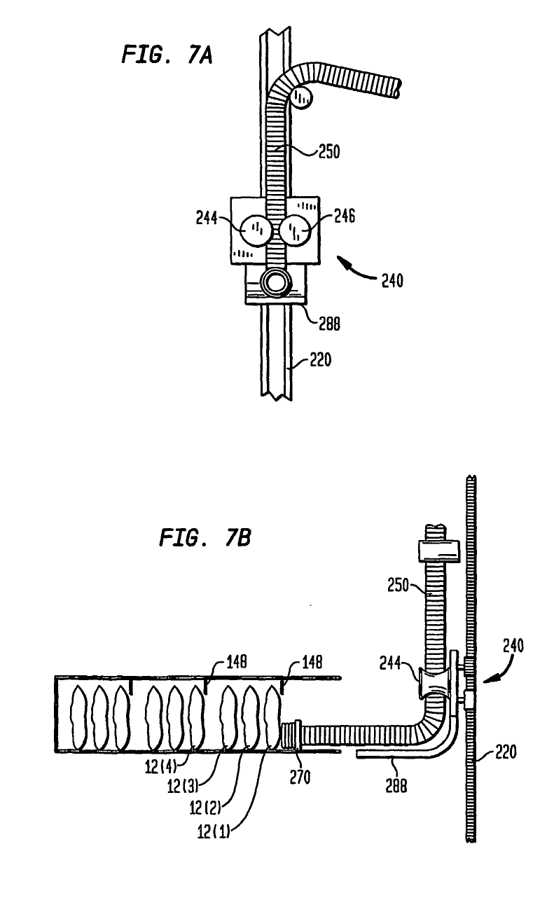

Features of the machine 10 that are not shown in FIGS. 1-8 include equipment for refrigerating the articles 12, equipment for heating the articles 12, a payment slot and change return, a consumer keypad for entering a selection of the available articles 12, an output device providing information to the consumer, a microprocessor controlling the operations of the machine 10, sensor(s) identifying the articles 12 being vended, sensor(s) tracking the movement of articles 12 and the article handler 200, and a communication link between the machine 10 and an external processor. The forenoted PCT patent applications show and describe examples of components/features such as these which are compatible with and can be used in machine 10.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A machine for vending articles, the machine comprising:
at least one compartment adapted to store the articles, the compartment extending along a longitudinal axis extending between first and second ends, the compartment including a guide extending parallel to the longitudinal axis;
a head being extensible into the compartment along a first axis that is generally parallel to the longitudinal axis, the head being adapted to engage one of the articles; and
a positioning mechanism aligning the head with the guide.

2. A machine for vending articles, the machine comprising:
at least one compartment adapted to store the articles, the compartment including a generally horizontal axis extending between first and second ends;
a head being extensible into the compartment along a first axis that is generally parallel to the generally horizontal axis, the head being adapted to engage one of the articles;
a positioning mechanism aligning the head with the compartment; and
a guide being provided in the compartment and controlling lateral movement of the head with respect to the first axis.

3. The machine according to claims 1 or 2, further comprising:
a hose providing a fluid coupling between the head and a vacuum source; and
a feeder displacing the hose so as to extend the head along the first axis.

4. A machine for vending articles, the machine comprising:
at least one article storage compartment, the compartment including a longitudinal axis extending between fist and second ends along which axis said articles are stored, the first end defining an article portal;
a head being extensible into the compartment, the head being extensible through the article portal and along a first axis that is generally parallel to the longitudinal axis, the head being adapted to engage one of the articles;
a guide being provided in the compartment and controlling lateral movement of the head with respect to the first axis;
a hose providing a fluid coupling between the head and a vacuum source;
a feeder displacing the hose so as to extend the head along the first axis; and
a positioning mechanism aligning the head with the compartment.

5. The machine according to claims 3 or 4, further comprising:
an enclosure defining an exterior space and an interior space including the first and second sets of compartments, the enclosure including an aperture adapted to pass the articles from the interior space to the exterior space.

6. A machine for vending articles, the machine comprising:
an enclosure defining an interior space and an exterior space, the enclosure having an aperture through which articles pass from the interior space to the exterior space;
a plurality of compartments in the interior space, each compartment storing a plurality of articles along a generally horizontal longitudinal axis of the compartment; and
a handler which moves successively further along the longitudinal axis of the compartments in order to engage successive ones of the stored articles, and then places the articles to be dispensed at the aperture.

7. The machine according to claim 6, wherein:
the plurality of compartments occupy at least 75% of the internal space.

8. A machine for dispensing articles, the machine comprising:
an enclosure defining an interior space and an exterior space, the enclosure having an aperture through which articles pass from the interior space to the exterior space;
a plurality of compartments in the interior space, each compartment storing a plurality of articles along a longitudinal axis of the compartment; and
a handler which moves successively further along the longitudinal axis of the compartment in order to engage successive ones of the stored articles, and then places the engaged articles to be dispensed at the aperture;
wherein the plurality of compartments occupy at least 75% of the internal space.

9. The machine according to claim 8, wherein:
the longitudinal axis of each compartment is generally horizontal, and
the handler occupies less than 25% of the internal space.

10. The machine according to claims 7 or 9, wherein the handler comprises a head, a guide, a hose, a feeder, and a positioning mechanism; the head is adapted to engage one of the articles and is extensible into the compartment along a first axis that is generally parallel to the longitudinal axis; the guide is provided in the compartment and controls lateral movement of the head with respect to the first axis; the hose provides a fluid coupling between the head and a vacuum source; the feeder displaces the hose so as to extend the head along the first axis; and the positioning mechanism aligns the head with the compartment.

11. The machine according to claims 5 or 10, wherein the at least one compartment comprises first and second sets of compartments, respective longitudinal axes of the first set of compartments are generally parallel and lie in a first generally horizontal plane, and respective longitudinal axes of the second set of compartments are generally parallel and lie in a second generally horizontal plane that is vertically spaced from the first horizontal plane.

12. The machine according to claim 11, further comprising:
a first tray defining a common base for the first set of compartments; and
a second tray defining a common base for the second set of compartments.

13. The machine according to claim 12, wherein the first tray is displaceable along the respective longitudinal axes of the first set of compartments such that the first ends of the first set of compartments abut at least one of the enclosure and the positioning mechanism.

14. The machine according to claim 12, wherein the first set of compartments comprise first and second subsets of compartments, the longitudinal axes of the first subset of compartments have a first length, and the longitudinal axes of the second subset of compartments have a second length that is shorter than the first length.

15. The machine according to claim 12, wherein the first tray is displaced along the respective longitudinal axes of the first set of compartments such that the first set of compartments is generally horizontally displaceable from the second tray.

16. The machine according to claim 12, wherein the longitudinal axes of the first set of compartments have a first length, and the longitudinal axes of the second set of compartments have a second length that is shorter than the first length.

17. The machine according to claim 12, wherein the first tray comprises at least one upright separating an adjacent pair of the first set of compartments.

18. The machine according to claims 5 or 10, wherein the compartment comprises at least one wall and at least one projection, the wall extends parallel to the longitudinal axis and is adapted to laterally position at least one of the articles with respect to the longitudinal axis, and the at least one projection is adapted to maintain an orientation of the articles that are not engaged by the head.

19. The machine according to claims 5 or 10, wherein the head is selected from the group consisting of at least one of a pneumatic gripper, a mechanical gripper, and a magnetic gripper.

20. The machine according to claim 19, further comprising:
a rotary joint coupling the head with respect to the hose.

21. The machine according to claims 5 or 10, wherein the positioning mechanism comprises first and second positioning devices.

22. The machine according to claim 21, wherein the first positioning device moves the feeder along a second axis perpendicular to the first axis, and the second positioning device moves the first positioning device along a third axis perpendicular to the first and second axes.

23. The machine according to claim 21, wherein the first positioning device moves the feeder along a second axis perpendicular to the first axis, and the second positioning device rotates the first positioning device about a third axis parallel to the first axis.

24. The machine according to claims 5 or 10, wherein the guide comprises a step portion of the compartment, the step portion extending substantially parallel to the respective longitudinal axis.

25. The machine according to claim 24, wherein the head comprises an enlarged portion contiguously engaging the step portion.

26. The machine according to claim 25, wherein the enlarged portion comprises a projection and the step portion comprises a groove contiguously receiving the projection.

27. The machine according to claim 25, wherein the step portion comprises a pair of rails projecting from a wall of the compartment and guiding the enlarged portion.

28. The machine according to claim 27, wherein the wall comprises a bottom horizontal surface of the compartment.

29. The machine according to claims 5 or 10, wherein the guide comprises an extension that is relatively rigid with respect to the hose, the extension includes a first portion secured to the head and a second portion secured to the feeder.

30. The machine according to claim 29, wherein the extension comprises a resiliently wound strip of spring metal.

31. The machine according to claims 5 or 10, wherein the enclosure comprises an at least partially transparent panel revealing at least one of the second end of the compartment and the positioning mechanism.

32. The machine according claim 31, wherein the at least partially transparent panel comprises advertising adapted to describe the articles.

33. The machine according to claim 31, wherein the enclosure comprises lighting adapted to illuminate the articles.

34. The machine according to claim 31, wherein the enclosure comprises a body having an aperture and a door movable between a first position occluding the aperture and a second position providing access to the interior space.

35. The machine according to claim 34, wherein the receptacle is mounted on the door.

36. The machine according to claim 34, further comprising a hinge connecting the door to the body, and a lock retaining the door in the first position.

37. The machine according to claims 5 or 10, wherein a transfer mechanism is adapted to move the articles from the head to the receptacle.

38. The machine according to claim 37, wherein the transfer mechanism consists of at least one of a chute and a conveyor.

39. The machine according to claims 5 or 10, wherein the feeder comprises a driver contiguously engaging the hose, the driver advances and retracts the hose along the first axis.

40. The machine according to claim 39, wherein the driver comprises a drive roller and a resiliently biased idle roller pressing the hose against the drive roller.

41. The machine according to claim 39, wherein the hose comprises a corrugated hose and the driver comprises a threaded rod cooperatively engaging the corrugated hose.

42. The machine according to claim 39, wherein the feeder comprises a platform extending toward the compartment and supporting the hose.

43. The machine according to claim 42, wherein the platform has a fixed length extending toward the compartment and supporting the hose.

44. The machine according to claim 42, wherein the platform has a variable length extending toward the compartment and supporting the hose.

45. The machine according to claims 5 and 10, wherein the hose comprises first and second segments, the first segment extends between the vacuum source and the feeder, the second segment extends between the feeder and the head, and the feeder displacing the hose changes the relative lengths of the first and second segments.

46. The machine according to claim 45, further comprising:
a storage system arranging the first segment of the hose as the feeder changes the length of the second segment relative to the length of the first segment.

47. The machine according to claim 46, wherein the storage system is oriented vertically.

48. The machine according to claim 47, wherein the storage system comprises a take-up mechanism acting on the second segment, the take-up mechanism consists of at least one of a gravity activated mechanism and a mechanically biased mechanism.

49. The machine according to claim 46, wherein the storage system is oriented generally horizontally.

50. The machine according to claim 49, wherein the storage system comprises a mechanically biased take-up mechanism acting on the second segment.

51. The machine according to claim 45, wherein the first segment comprises a relief valve.

52. A method of vending articles from a machine, the machine including an interior space having therein at least one compartment extending along a generally horizontal axis between first and second ends, and the compartment having therein a plurality of articles, the method comprising:
aligning a head with the compartment, the head being adapted to engage the articles;
extending the head into the compartment along a first axis generally parallel to the generally horizontal axis;
engaging one of the plurality of articles with the head; and
retracting along the first axis the head with the article engaged by the head, the retracting leaves substantially undisturbed the non-engaged ones of the plurality of articles.

53. The method according to claim 52, further comprising:
displaying an example of the plurality of articles.

54. The method according to claim 53, wherein the displayed example comprises the one of the plurality of articles that is last engaged by the head during the engaging and the retracting.

55. A method of stocking a machine for vending articles, the method comprising:
accessing a compartment in an interior space of the machine, the compartment including a generally horizontal axis extending between first and second ends; and
inserting along the generally horizontal axis at least one of the articles in the compartment.

56. The method according to claim 55, wherein the inserting comprises concurrently displacing a plurality of the articles along the generally horizontal axis.
